(19) United States
(12) Patent Application Publication
(10) Pub. No.: US 2024/0227037 A1
(43) Pub. Date: Jul. 11, 2024

(54) DEVICE FOR ASSISTANCE IN DRILLING A BOARD

(71) Applicant: MAF AGROBOTIC, Montauban (FR)

(72) Inventor: Jacques Monjo, La Crau (FR)

(21) Appl. No.: 18/557,934

(22) PCT Filed: Apr. 27, 2022
(86) PCT No.: PCT/EP2022/061195

§ 371 Date: Oct. 28, 2023

(30) Foreign Application Priority Data
Apr. 30, 2021 (FR) 2104551

(51) Int. Cl. B23B 47/28; B23B 51/10

(52) U.S. Cl. CPC B23B 47/287; B23B 51/104; B23B 2247/04

(57) ABSTRACT

A device assists in drilling a board with a tool having a drill bit, means for rotatably driving the bit, and a guide member—having an outer face with a generally cylindrical shape of revolution about the bit's rotation axis—for guiding the bit in rotation and movement along the bit's longitudinal axis. The device has a rigid body with a flat sole (contact surface). Guide space(s) pass through the rigid body and open onto the sole. Each guide space is delimited laterally toward the outside by a cylindrical internal surface of revolution about a revolution axis orthogonal to the sole's main plane. The internal surface may interact with the guide member and guide the bit in rotation and longitudinal movement along the revolution axis. The internal surface has a radial expansion for stopping, in abutment therewith, the guide member during longitudinal movement of the tool toward the board.

### CROSS-REFERENCE TO RELATED APPLICATIONS

This application is a national phase entry under 35 U.S.C. § 371 of International Patent Application PCT/EP2022/061195, filed Apr. 27, 2022, designating the United States of America and published as International Patent Publication WO 2022/229256 A1 on Nov. 3, 2022, which claims benefit, under Article 8 of the Patent Cooperation Treaty, of French Patent Application Serial No. FR2104551, filed Apr. 30, 2021.

### TECHNICAL FIELD

The disclosure relates to a device for assistance in the esthetic and precision drilling of a floor slat, notably a terrace floor slat. However, the disclosure also relates to a device for assistance in the esthetic and precision drilling/countersinking, in a single step, of such a floor slat.

### BACKGROUND

In general, outdoor terraces are made up of a structure formed of joists supporting floor slats, each slat being fixed to joists by means of screws passing through the slat and rigidly securing the slat by screwing to the joists.

To preserve the esthetic appearance of the terrace, it is desirable that the screw heads visible at the surface of the terrace slats have as regular a distribution as possible. In general, the screws are arranged regularly in each corner of each rectangular slat. For example, each screw may be screwed such that it extends at a distance of 2 cm from each side of each corner of the slat. In addition, it may be necessary to place at least one additional screw along the length of each slat, depending on the length of the slats. In this regard, it is common to provide for spacing between two adjacent screws that is between 650 mm and 800 mm. To obtain this regularity in the distribution of the screw heads, it is necessary, to date, to measure this spacing and trace on each slat the position of each drill hole, before proceeding with the through drilling of the slat and the partial drilling of the underlying joist, then going on to countersink the slat so as to form a countersink for receiving the screw head, before proceeding to insert the screw by screwing, fixing the slat on the joist(s).

This tracing is time-consuming, tedious and often imprecise.

On the one hand, such tracing requires prior measurement of the position of each screw on the surface of the slat, then tracing of this position with a view to drilling. This measurement is likely to be flawed by error, such that the position of the drill hole (and of the screw corresponding to this drill hole) is likely not to be regular in relation to all of the drill holes (and corresponding screws) of the terrace.

Moreover, such tracing—notably such tracing with a pencil—although it must be visible to enable drilling to be guided and carried out, must, in order to preserve the esthetics of the terrace, be erased after drilling. Such erasure can be tricky depending on the surface roughness of the slat, and in any case, it contributes to increasing the time required for mounting the slat. Furthermore, there is a risk that this tracing will remain visible on the surface of the terrace, to the detriment of its esthetics.

Furthermore, such tracing may be imprecise when the surface of the slat is not perfectly flat and even—for example, when the slat has longitudinal non-slip grooves—and the tracing must be carried out on a recessed part of the slat. Such tracing on a recessed part is very difficult to erase, due to the difficulty in accessing the bottom of the grooves.

Furthermore, there is a risk that the drilling will not be carried out with the drilling axis substantially orthogonal to the main plane of the slat. Such oblique drilling also causes an esthetic defect since the accessible face of the head of the screw does not extend substantially in the plane forming the upper face of the slat. In addition to the unsightly appearance resulting from such oblique screwing, part of the screw head may protrude from the face of the slat on which people walk or stand and form an irregularity in the surface of the terrace, constituting an obstacle for users of the terrace who are likely to stumble on this obstacle and/or to be injured by getting caught on the protruding part of the screw, or even to trip over it.

Furthermore, with regard to the mounting of slats on joists using long screws—notably a screw with a length of between 40 mm and 60 mm, for example 50 mm—relative to the diameter of the screw shank in cross section—notably a diameter of between 4 mm and 5 mm, for example 4.5 mm—the installation by screwing of such a screw in an oblique drill hole increases the risk of the screw breaking as a screwing thrust is applied along an axis substantially normal to the main plane of the slat combined with the rotation of the screw. The slat in which the fragment of the broken screw with the pointed end is embedded is no longer usable, as it is not possible to remove this fragment from the slat for the purpose of replacing it with a new replacement screw. The slat must necessarily be replaced. Such mounting is therefore not economically optimal.

A device, referred to as a “precision template for terrace screws,” for assistance in drilling a terrace floor slat, is known. This known device comprises two spacer plates that may be modulated by sliding relative to one another in a longitudinal direction of the drilling assistance device. Each of the two plates of this known device has a lower face intended to be applied to a main face of the slat to be drilled and a hole passing through the plate, with a circular edge and dimensioned such that a drill bit, mounted such that it rotates as one with a chuck of a portable drill, can pass through it. Each through hole is provided with a cylindrical tube of revolution, for centering and guiding the chuck (and the drill bit) in rotation and as it advances in the direction of the slat. Each centering tube extends from the upper face, opposite the lower face intended to be placed in contact with the slat, of the corresponding plate, the axis of revolution of each cylindrical tube being orthogonal to the main plane of the corresponding lower face. Furthermore, in this known device, the diameter of each hole corresponds precisely to the internal diameter of each cylindrical tube such that the longitudinal travel of the chuck in the cylindrical tube is only limited when the rotating chuck comes into contact with the slat. This contact between the rotating chuck and the slat being drilled poses a problem. To be specific, the rotating chuck coming into contact with the slat is likely to mark the slat and be detrimental to the esthetics of the terrace.

It is proposed, to overcome this drawback, to use a specific connection device adapted to be able to be mounted such that it rotates as one with a chuck of a portable drill via one of its longitudinal ends and with a drill bit via its other longitudinal end. Such a known connection device is equipped with a stop of substantially tubular shape, mounted coaxially with respect to the connection device, with the connection device passing longitudinally through it, and able to rotate freely with respect to the connection device by means of a bearing. Thus, during drilling, when the stop comes into contact with the slat being drilled, the connection device and the drill bit can continue to rotate without forcing the rotation of the connection device pressed in contact with the slat. This solution is complex and not reliable due to the possibility of the stop becoming stuck on the connection device, risking marking the slat during drilling.

U.S. Pat. No. 5,743,683 describes a device for countersinking a head of a headed rivet. EP3517234 and DE202009005279 each describe a device for assistance in the positioning of holes to be drilled. U.S. Pat. No. 2,674,906 describes a device for controlling the spacing of holes to be drilled and WO2018/220312 describes a surface protection ring for a panel to be drilled.

### BRIEF SUMMARY

Embodiments of the disclosure aim to overcome one or more above-mentioned drawbacks by proposing a device for assistance in drilling—notably for assistance in drilling/countersinking—a floor slat that makes it possible to completely eliminate a tracing step.

Embodiments of the disclosure also aim to overcome one or more above-mentioned drawbacks by proposing a device for assistance in drilling—notably for assistance in drilling/countersinking—a floor slat that makes it possible to limit, or even completely eliminate, the risk of a screw breaking when it is screwed into a slat and a joist.

Embodiments of the disclosure also aim to overcome one or more above-mentioned drawbacks by proposing a device for assistance in drilling—notably for assistance in drilling/countersinking—a floor slat that makes it possible to preserve the esthetics of a floor and a terrace comprising same.

Embodiments of the disclosure also aim to overcome all of the aforementioned drawbacks by proposing a device for assistance in drilling—notably for assistance in drilling/countersinking—a floor slat that is simple in its design and that makes it possible, despite this simplicity, to preserve the esthetics of this floor and the terrace comprising it.

Embodiments of the disclosure also aim to provide such an assistance device making it possible to lay slats of a terrace without using a tape measure, without using a line, without using a square and without using a tracing pencil.

Embodiments of the disclosure also aim to provide such an assistance device making it possible to lay terrace slats with great precision.

Embodiments of the disclosure also aim to provide such an assistance device making it possible to reduce the time required to lay terrace slats.

To this end, the disclosure relates to a device for assistance in drilling through—notably for assistance in drilling/countersinking—a board—notably but not exclusively a slat for the production of a terrace floor—by means of a drilling tool of the type equipped with a drill bit—and where applicable a cutter mounted coaxially on the drill bit—, means for driving in rotation this drill bit and a guide member for guiding this drill bit in rotation—relative to the longitudinal axis of this drill bit—and in movement along the longitudinal axis of this drill bit, the guide member having an outer face of generally cylindrical shape of revolution about the axis of rotation of the drill bit; the assistance device comprising a rigid body having a flat sole forming a surface, referred to as the contact surface, of the rigid body intended to be in contact with the board;
the rigid body having at least one guide space forming a bore passing through the rigid body and opening onto the flat sole;
each guide space being delimited laterally toward the outside by a cylindrical internal surface of revolution about an axis of revolution orthogonal to the plane of the sole, the internal surface being adapted to be able to interact with the guide member and guide the drill bit in rotation and in longitudinal movement along this axis of revolution;
characterized in that the internal surface of each guide space has a radial expansion—notably a radial ring—for stopping the guide member in abutment on this radial expansion during the longitudinal movement of the drilling tool in the direction of the board, the radial expansion extending into the guide space from the internal surface and forming an axial cavity dimensioned such that the drill bit can pass through it.

The disclosure therefore relates to a device or “template” or “guide” for assistance in drilling a board or a slat of wood, notably a slat of wood for making a terrace floor.

According to embodiments of the disclosure, when drilling a wooden board or slat, the drill bit is driven in rotation—notably by an electric motor of the drilling tool—and the outer face of the guide member interacts with the inner face of the guide space for guiding the drilling tool and the drill bit, moving orthogonally to the main plane of the board, whereby drilling is carried out along an axis orthogonal to the main plane of the board. Owing to this orthogonal drilling, the subsequent screwing of the screw into a joist through the board will be facilitated and carried out while limiting the risk of breakage of the screw.

On the other hand, the movement in the longitudinal direction of the guide member and the drill bit—and where applicable of the cutter—is stopped when the guide member comes into contact with the radial expansion extending from the inner face of the guide bore and forming a radial stop. Thus, the distal end of the guide member driven in rotation is prevented from coming into contact with the board and the esthetic appearance of the latter is preserved, including when the guide member is kept in rotation. For the same reasons, the depth of the countersink is perfectly controlled to a depth necessary to accommodate the screw head.

In certain advantageous embodiments, there is nothing to prevent provision being made to equip the drill bit with a rotary cutter intended to form a hollow countersink for receiving the head of a countersunk screw. In these embodiments, drilling/countersinking allows the head of the countersunk screw not to extend in relief relative to the constructed surface—notably relative to the accessible surface of the terrace intended to be walked on—and not to constitute an obstacle for people moving around on this surface. In these embodiments, it is sufficient to provide for the internal diameter of the radial stop to be sufficiently small to allow the stop to interact in abutment with the distal end of the guide member and stop the guide member in longitudinal movement in the direction of the board, and sufficiently large to allow engagement of the cutter through the stop, without damaging the stop, this engagement being limited due to the stop halting the advance of the guide member, the advance of the drill bit and, where applicable, the advance of the cutter. The drilling assistance device according to embodiments of the disclosure makes it possible to carry out such drilling and such countersinking in a single drilling/countersinking step, that is to say in a single advancing movement of the drilling tool against the board allowing drilling and subsequent countersinking, which nevertheless preserves the esthetic appearance of the board and the terrace slat.

The radial expansion forming a stop may have any shape adapted to stop the longitudinal travel of the guide member, of the drill bit, and where applicable of the cutter. It has the shape of a continuous circular peripheral ring. However, there is nothing to prevent provision being made for the radial expansion to be formed of a plurality of—notably three—annular sectors forming radial notches. There is also nothing to prevent provision being made for the radial expansion to be formed of a plurality of radial bumps forming a discontinuous ring. Such radial notches and such bumps make it possible to promote the evacuation of the sawdust formed during drilling and, where applicable, during countersinking.

According to some advantageous embodiments, the rigid body has a plurality of guide spaces, notably two guide spaces. According to these embodiments, each guide space of the plurality of guide spaces opens onto the flat sole. Advantageously, the internal face of each guide space of the plurality of spaces has a radial expansion to stop the guide member in abutment on this radial expansion during the longitudinal movement of the drilling tool in the direction of the board. According to some embodiments, the body has two guide spaces passing through the body, each guide space opening onto the flat sole. Advantageously, the inner face of each of the two guide spaces has a radial expansion to stop the guide member. According to these embodiments, the drilling assistance device makes it possible to drill a plurality of drill holes—notably two drill holes—separated laterally from one another by a perfectly controlled distance owing to the spacing of the guide spaces formed in the rigid body, and without requiring measurement of the distance separating the two drill holes and/or unsightly tracing.

According to some advantageous embodiments, at least one part of the rigid body is in the form of at least one rigid plate, the at least one rigid plate forms the flat sole and at least one rigid plate—notably each rigid plate—has a guide space. According to some advantageous embodiments, the body of the drilling assistance device comprises a single rigid plate forming the flat sole. There is nothing to prevent provision being made for the single rigid plate to have a single guide space forming a single guide bore. That being so, according to some embodiments, it is advantageous to provide for the single rigid plate to have a plurality of guide spaces, notably two guide spaces. In these embodiments, the guide spaces are separated laterally by a distance that is fixed owing to the single nature of the plate and the position of the guide spaces on this plate. The use of a drilling assistance device according to this embodiment makes it possible to carry out operations of drilling pairs of holes, the holes of the pair of holes being separated by a fixed and reproducible distance. There is also nothing to prevent provision being made for the drilling assistance device according to embodiments of the disclosure to have a plurality of plates, notably two plates, the plates of the plurality of rigid plates being provided with means for adjusting the spacing of these plates in relation to one another, notably one in relation to the other. There is also nothing to prevent provision being made for each plate of the plurality of rigid plates to comprise a—notably a single—guide space. In these embodiments, modifying the means for adjusting the spacing makes it possible to predefine the spacing of the guide spaces and to carry out operations of drilling pairs of holes, the holes of the pair of holes being separated by a distance that is fixed and reproducible, but also adjustable as required.

According to some advantageous embodiments, the flat sole of the rigid body, intended to be in contact with the board, is rectangular in shape. In these advantageous embodiments, the flat sole has a length of between 100 mm and 200 mm, notably between 120 mm and 170 mm, in particular of the order of 145 mm. However, there is nothing to prevent provision being made for the length of the flat sole to be of the order of 125 mm. The length of the flat sole is chosen to be of the order of magnitude of—notably substantially equal to—the width of the terrace slats to be drilled and laid. In some embodiments, the drilling assistance device has a plurality of guide spaces, notably two guide spaces, the guide spaces forming an alignment of guide spaces parallel to the length of the sole. In some of these embodiments, the assistance device has a plurality of guide spaces, notably two guide spaces, the guide spaces forming an alignment of guide spaces extending along a median of the rectangular sole.

According to some advantageous embodiments, the internal surface delimiting each guide space is formed of an internal surface of a portion of cylindrical tube of revolution extending from the flat sole into a half-space, referred to as the drilling space, opposite the half-space extending facing the contact surface. In these embodiments, the guide space(s) is(are) limited by the tube portion(s) extending orthogonally to the flat sole. The portions of cylindrical tube of revolution each have an axis of revolution parallel to the axis of revolution of the other tube portion(s). According to these embodiments, the drilling assistance device comprises a median reinforcement, joining a rigid plate and at least one—notably each—tube portion, the median reinforcement extending in a plane orthogonal to the rigid plate. The bending rigidity of the rigid body and/or the rigid plate of the drilling assistance device is tested during drilling, the guide surfaces are kept parallel to one another, control of the drilling orientation is improved and the esthetics are optimal. The drilling assistance device and the manufacture thereof are also simplified.

According to some advantageous embodiments, the flat sole of rectangular shape is extended by a rim, referred to as the lateral guide rim, for guiding the drilling assistance device in lateral movement along the board, the lateral guide rim extending:
protruding relative to the contact face of the flat sole;
from only one of four edges of the flat sole of rectangular shape; and
in the half-space extending facing the contact surface.

According to some advantageous embodiments, the axes of revolution of each cylindrical internal surface of revolution delimiting each guide space have an axis of alignment orthogonal to a contact plane of the lateral guide rim via which it makes contact with the board. In these embodiments, with the lateral guide rim extending in a plane orthogonal to the main plane of the flat sole, the axis of alignment of the guide spaces is orthogonal to the plane of the lateral guide rim. In these embodiments, the axis of alignment of the guide spaces is parallel to an edge of at least one rigid plate and/or to an edge of the flat sole of rectangular shape. Thus, the lateral guide rim forms a stop extending perpendicularly to the axis of alignment of the guide cylinders. In these embodiments, the drilling assistance device forms a stop interacting with an edge of the floor slat and the drilled holes made in the slat are perfectly aligned, such that the fixing screws in the slats are perfectly aligned and contribute to the esthetics of the floor. The drilling assistance device makes it possible to obtain such esthetic alignment without measuring or tracing.

According to some advantageous embodiments, with the device comprising a plurality of cylindrical tube portions, the portions are arranged in such a way as to form an alignment of portions, with an axis of alignment perpendicular to the lateral guide rim.

According to some advantageous embodiments, the cylindrical internal surfaces of revolution delimiting each guide space have the same diameter in cross section. The guide spaces are thus adapted to be able to interact with the same guide member.

According to some advantageous embodiments, the drilling assistance device comprises a centering guide having a slot—notably an oblong slot—positioned such that a screw head inserted in the terrace can be seen through this slot and such that at least one—notably each—of the guide spaces—notably of the tube portions—can be aligned with the screw inserted. Such a centering guide allows drilling and alignment of the screws of a second slat to be fixed in relation to the screws of a first slat previously assembled to the terrace.

According to some advantageous embodiments, the centering guide is removable with respect to the rigid body—notably with respect to the flat sole—and has at least one hole adapted to be able to receive and interact with at least one peg on the rigid body in such a way as to rigidly secure the removable centering guide and the rigid body by means of a non-deformable rigid connection. Furthermore, according to some embodiments, the removable centering guide has a gap adapted to be able to interact with the portion of cylindrical tube of revolution in such a way as to rigidly secure the removable centering guide and the rigid body by means of a non-deformable rigid connection.

According to some advantageous embodiments, the drilling assistance device comprises a rigid arm for spacing the assistance device relative to a drill hole made in the board, the spacing arm being an arm of adjustable length, mounted rigidly secured to the rigid body and having at its longitudinal end opposite its end rigidly secured to the rigid body, a centering stud—notably selected from a centering stud of generally cylindrical shape, a centering stud of generally conical shape and a centering stud of generally frustoconical shape—dimensioned to be able to interact with the drill hole made in the board and keep the rigid body of the assistance device at a predetermined distance from the drill hole made in the board. Such a rigid spacing arm makes it possible to produce drilled holes that are regularly spaced along the length of the board—notably along the length of the slat—and aligned with the drilled holes in adjacent boards or slats.

According to some advantageous embodiments, at least one radial expansion has at least one radial notch for evacuating sawdust during drilling. According to some embodiments, each radial expansion has three radial notches regularly distributed over the radial expansion.

According to some advantageous embodiments, each guide space has a depth chosen and adapted to be at least equal to the distance separating the distal drilling end of the drill bit and the distal end of the guide member. Advantageously, each guide space has a depth chosen and adapted to be greater than the distance separating the distal drilling end of the drill bit and the distal end of the guide member. Very advantageously, each guide space has a depth chosen and adapted such that the internal surface of the guide space and the outer face of the guide member have a minimum height of overlap before drilling of greater than 10 mm, notably greater than 15 mm. Thus, the guide member is fully engaged in the guide space of the drilling assistance device before drilling starts, for better centering of the drill bit—and where applicable the cutter—in the guide space. In this way, the drill bit—and where applicable the cutter—is centered in the guide space and drilling is perfectly controlled and esthetically pleasing. Moreover, drilling and countersinking are perfectly concentric. According to some embodiments, each guide space has a depth of between 50 mm and 80 mm, notably of the order of 60 mm.

Throughout the text, the term “distal end” of an element or member of the drilling tool means the longitudinal end of this element or member extending toward the drilling end of the drill bit, when the drilling tool is in the drilling state. The term “proximal end” of an element or member of the drilling tool means the longitudinal end of this element or member extending opposite the drilling end of the drill bit, when the drilling tool is in the drilling state.

According to some advantageous embodiments, the drilling assistance device comprises at least one alignment member for aligning the rigid body on a longitudinal end edge of the board, the alignment member being removable relative to the rigid body and having at least one hole adapted to be able to receive and interact with at least one peg on the rigid body in such a way as to rigidly secure the alignment member and the rigid body (2) by means of a non-deformable rigid connection;
the alignment member having a rim, referred to as an alignment rim, extending:
   protruding relative to the contact face of the flat sole; and
   in the half-space extending facing the contact surface.

According to some advantageous embodiments, the drilling assistance device is equipped with two alignment members for aligning the rigid body, each of the two alignment members being adapted to be able to align the drilling assistance device on one of the opposite edges of longitudinal ends of the board. It may be equipped with, alternatively:
a right-hand alignment member having a rim, referred to as an alignment rim, extending to the right of the alignment member when the assistance device equipped with the right-hand alignment member is placed at the right-hand end of the board; and
a left-hand alignment member having a rim, referred to as an alignment rim, extending to the left of the alignment member when the assistance device equipped with the left-hand alignment member is placed at the left-hand end of the board.

It may also be alternatively equipped with a rigid arm for spacing the assistance device relative to a drill hole previously made in the board.

According to some advantageous embodiments, the rigid body is shaped so as to have a gripping member forming an ergonomic handle. Advantageously, the drilling assistance device is in one piece, that is to say formed in a single piece, from a single material. Advantageously, the rigid plate(s), the median reinforcement, the cylindrical tube(s) and the ergonomic handle are formed in a single piece, from a single material.

According to some advantageous embodiments, the drilling tool being equipped with a cutter mounted coaxially and such that it rotates as one with the drill bit, the central cavity in the radial expansion is dimensioned such that the cutter can pass through it. The assistance device according to embodiments of the disclosure very advantageously makes it possible to make, in a single drilling movement, a drill hole in the board—notably in the slat—and a countersink for receiving a screw head.

The disclosure also extends to a method for drilling—notably drilling/countersinking in a single step—through a board, wherein:
a drilling tool is selected, the drilling tool being equipped with a drill bit—and, where applicable, with a cutter mounted coaxially with and rigidly secured to the drill bit—, means for driving in rotation this drill bit and a guide member for guiding this drill bit in rotation and in movement along the longitudinal axis of this drill bit, the guide member having an outer face of generally cylindrical shape of revolution about the axis of rotation of the drill bit; and
a device for assistance in drilling through a board according to embodiments of the disclosure is used, in such a way as to carry out regular and esthetic drilling—notably drilling/countersinking—of the board without taking measurements and without tracing.

The disclosure also relates to a device for assistance in drilling—notably for assistance in drilling/countersinking in a single step—and to a drilling method characterized, in combination or otherwise, by all or some of the features mentioned above or below. Whatever the formal presentation given, unless explicitly stated otherwise, the various features mentioned above or below should not be considered as closely or inextricably linked to one another, and the disclosure may relate to just one of these structural or functional features, or only some of these structural or functional features, or only part of one of these structural or functional features, or indeed to any grouping, combination or juxtaposition of all or some of these structural or functional features.

### BRIEF DESCRIPTION OF THE DRAWINGS

Other aims, features and advantages of embodiments of the disclosure will emerge on reading the following description of some possible but non-limiting embodiments of the disclosure, referring to the accompanying drawings in which:

FIG. 1 is a side view of a tracing assistance device according to embodiments of the disclosure;

FIG. 2 is a top view of a tracing assistance device according to embodiments of the disclosure;

FIG. 3 is a view in median longitudinal section along the plane III-III shown in FIG. 2 depicting a detail of a tracing assistance device according to embodiments of the disclosure;

FIG. 4 is an exploded perspective view depicting possible uses of a plurality of variants of a tracing assistance device according to embodiments of the disclosure;

FIG. 5 is a view in section of a detail of a tracing assistance device according to embodiments of the disclosure, shown in interaction with a drilling tool;

FIG. 6 is a general plan view depicting the use of a variant of a drilling assistance device according to embodiments of the disclosure for drilling a terrace slat;

FIG. 7 is a perspective view of a spacing arm that can be used in association with the solid body of an assistance device according to embodiments of the disclosure;

FIG. 8 is a perspective view of a detail of a drilling tool that can be used in association with a drilling assistance device according to embodiments of the disclosure; and

FIG. 9 is a general plan view depicting a particular mode of use of a drilling assistance device according to embodiments of the disclosure for drilling a long terrace slat to be placed along the edge of a wall.

### DETAILED DESCRIPTION

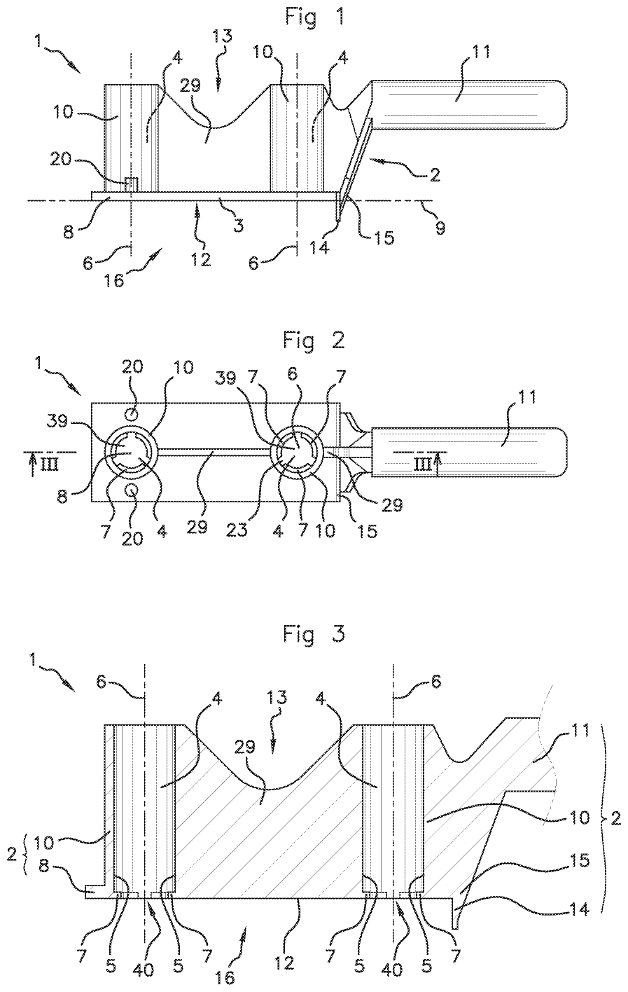

An embodiment of a device 1 for assistance in drilling a board in general, and a floor slat for creating a terrace in particular, is shown in FIG. 1. Below, the following description will relate to a device 1 for assistance in drilling a terrace slat and to a method for drilling through a terrace slat for the purposes of laying a floor of the terrace. However, the following description does not limit the invention or embodiments of this disclosure to this use alone, the assistance device 1 according to embodiments of the disclosure being suitable for any use in which precise and esthetic drilling of a board other than a terrace floor slat is sought. Such an assistance device 1 is formed of a rigid body 2 forming a flat sole 8. In the embodiment shown, the flat sole 8 is formed of a rigid plate (such that the flat sole 8 may also be referred to herein as the rigid plate 8) having a surface, referred to as the contact surface 12, which is flat and adapted and intended to be brought into contact with a main face of a terrace slat to be drilled. In the embodiment shown, the rigid plate 8 has a thickness of the order of 5 mm. The rigid body 2 also forms a rigid guide rim 14 of the assistance device 1 intended to interact with an edge of the slat to be drilled and to guide the assistance device along this edge. The guide rim 14 forms a flat tongue extending perpendicularly to the contact surface 12 from an edge 15 of the flat sole. The guide rim 14 allows translational movement of the assistance device 1 relative to the slat, parallel to the edge of the slat, such that the drilled holes made are necessarily aligned parallel to the edge of the slat. The esthetic appearance of the terrace is preserved. The rigid body 2 has two portions 10 of cylindrical tubes of revolution, each portion 10 laterally delimiting an internal guide space 4 having an internal surface 5 of cylindrical shape of revolution about an axis 6 orthogonal to the plane of the contact surface 12. The rigid body 2 also has a member for gripping the assistance device 1, the member forming an ergonomic handle 11 and adapted to allow the contact surface 12 to be placed on a slat for building a terrace. In the assistance device 1, the rigid body 2 forms a reinforcement 29 extending in a median plane of the assistance device 1 and interacting with the rigid plate 8 to stiffen the rigid plate 8 in bending. The median reinforcement 29 also interacts like a rib with the tube portions 10 to keep them orthogonal to the rigid plate 8 during drilling of the slat. It also interacts like a rib with the ergonomic handle 11 to keep the contact surface 12 of the rigid plate 8 in contact with the surface of the slat while it is being drilled. The assistance device 1 according to the embodiment shown in FIG. 1 is lightweight and easy to handle. In the embodiment shown, the wall of the cylindrical tube portions 10 and the median reinforcement 29 have a thickness of the order of a few millimeters, notably of the order of 2.5 mm.

An assistance device 1 according to embodiments of the disclosure may be made of any suitable material having sufficient rigidity with regard to the stresses applied to the assistance device 1 during drilling. An assistance device 1 according to embodiments of the disclosure may be formed in a single piece, from a single material. It may advantageously be produced by 3D printing, also referred to as additive manufacturing. It may thus be made of at least one polymer material. However, there is nothing to prevent the assistance device 1 from being made by thermoforming or by thermos-molding of a thermoplastic polymer. There is also nothing to prevent the assistance device 1 from being made of at least one thermosetting material. There is also nothing to prevent the assistance device 1 from being made of at least one metal.

The assistance device 1 according to embodiments of the disclosure is particularly suitable for assisting drilling prior to fixing by means of very long screws, for example screws with a length of between 40 mm and 60 mm, notably a length of the order of 50 mm, and with a small section, notably having a diameter with a cross section of the order of 4.5 mm. On the one hand, such screws with a diameter of small cross section require the use of a drill bit that is itself small in diameter and adapted to the diameter of the screw, and therefore fragile, to carry out preliminary drilling. Drilling along a drilling axis that is not orthogonal to the plane of the slat promotes torsional stresses exerted on the drill bit during drilling. There is a risk of the drill bit breaking due to this fragility, with part of the drill bit remaining trapped in the slat. In the event that the drill bit breaks, the slat and the drill bit must be replaced. The assistance device 1 according to embodiments of the disclosure makes it possible to at least minimize, and even completely eliminate, the risk of the drill bit breaking during drilling, by virtue of the fact that it forces drilling to be performed along a drilling axis orthogonal to the plane of the slat. Furthermore, such screws are relatively fragile and require that a preliminary drilled hole be made perfectly orthogonal to the plane of the slat to allow subsequent screwing along a screwing axis itself orthogonal to the plane of the slat so as to minimize the risk—or even eliminate all risk—of breakage of the screw in the slat as it is screwed. This is because if such breakage occurs, the slat cannot be attached and the slat containing the screw fragment must be replaced and scrapped.

An embodiment of a device 1 for assistance in drilling a floor slat for building a terrace is shown in top view in FIG. 2. The assistance device 1 shown is formed of a rigid body 2 comprising a rigid plate 8 of rectangular shape with a length substantially of the order of 125 mm and a width substantially of the order of 50 mm. The rigid body 2 comprises an ergonomic handle 11 and a median reinforcement 29 joining together the ergonomic handle 11, the rigid plate 8 and two portions 10 of cylindrical tubes of revolution. The rigid plate 8 has a main face, referred to as the upper face 39, from which there extend the cylindrical tube portions 10 forming the guide spaces 4 and the median reinforcement 29. Each tube portion 10 forms a guide space 4 passing through the tube portion 10 and opening onto the half-space extending facing the contact face. Each guide space 4 is limited laterally by its internal surface 5 of cylindrical shape of revolution about the axis 6 of revolution. As shown in FIG. 2, each portion 10 of cylindrical tube of revolution has a radial expansion 7 extending radially from the internal surface 5 inside the guide space 4. The radial expansion 7 forms a stop for stopping the guide member in longitudinal movement of the guide member and the drill bit in this guide space 4. The radial expansion 7 is a purely peripheral expansion forming a central cavity for the passage of the drill bit and, where applicable, a cutter for the creation of a countersink for receiving a screw head. By virtue of this stop, the guide member of the drilling tool does not make contact with the slat on which the contact surface 12 and the assistance device 1 rest. As a result, contact between the drilling tool and the slat is limited to contact between the drill bit—and where applicable the cutter—and the slat, and the guide member driven in rotation does not mark the slat. The esthetics of the slat and the terrace floor are preserved.

A detail of the embodiment of the assistance device 1 of FIG. 2 is shown in FIG. 3, in section along the median plane III-III of FIG. 2. The rigid body 2 of the assistance device 1 shown in FIG. 3 is formed, in a single piece from a single material, of a rigid plate 8, a guide rim 14, an ergonomic handle 11 and a median reinforcement 29 joining together the ergonomic handle 11, the rigid plate 8, the guide rim 14 and two tube portions 10. Each tube portion 10 is cylindrical of revolution about the axis 6 and forms a guide space 4 passing longitudinally through the tube portion 10. Each guide space 4 opens into the drilling half-space 13 at one of the longitudinal ends of the tube portions 10 and into the half-space 16 extending facing the contact face 12 (also referred to herein as the “contact surface” 12). Each guide space 4 is limited laterally by the internal surface 5 of the corresponding tube portion 10. Each internal surface 5 has a cylindrical shape of revolution about the axis 6 of revolution. The axis 6 of revolution is orthogonal to the contact face 12 such that drilling, guided by the guide space 4, is performed orthogonally to the contact face 12 and to the main face of the slat. Each tube portion 10 has a radial expansion 7 extending radially from the internal surface 5 inside the guide space 4. The radial expansion 7 is formed in such a way as to be flush with the surface of the contact face 12. The radial expansion 7 has sufficient thickness to form the stop for stopping the guide member. The radial expansion 7 is dimensioned to form a central cavity 40 for the passage of the drill bit and, where applicable, a cutter for producing a countersink for receiving a screw head.

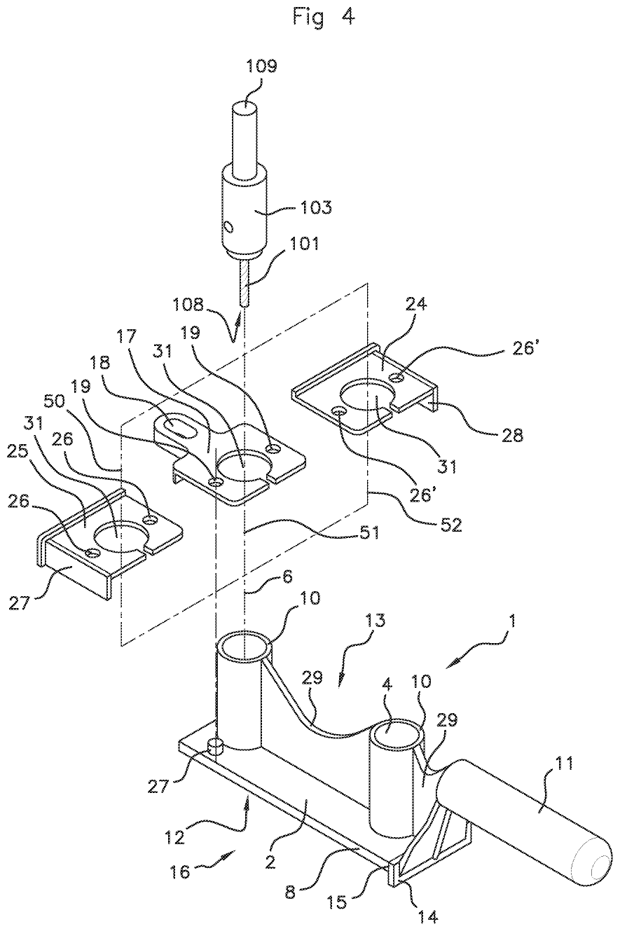

An exploded perspective view of three possible embodiments of an assistance device 1 according to the disclosure interacting with a drilling tool is shown in FIG. 4. The assistance device 1 comprises a rigid body formed, in a single piece from a single material, of a rigid plate 8, a guide rim 14, an ergonomic handle 11 and a median reinforcement 29 joining together the ergonomic handle 11, the rigid plate 8, the guide rim 14 and two tube portions 10. As shown in FIG. 4, one of the tube portions 10 interacts with a guide member 103 provided at its distal end 110 with a drill bit 101. The guide member 103 and the drill bit 101 are driven in rotation by a drilling tool (not shown in FIG. 4) interacting with the proximal end 109 of the guide member 103.

According to a first embodiment 50, the rigid body 2 is provided with an alignment member 25 having an alignment rim 27 for aligning the assistance device 1 on one of the longitudinal ends of a slat. In this first embodiment 50, the rim 27 of the alignment member 25 protrudes relative to the contact surface 12 such that the position of the tube portions 10 relative to the slat is dictated by the guide rim 14 and by the alignment rim 27 when the rigid body 2 is placed in abutment on the two contiguous edges of the slat. In this first embodiment 50, with the user positioned on the side of the ergonomic handle 11 and facing the terrace being constructed, the assistance device 1 according to this first embodiment 50 makes it possible to position the rigid body 2 on and proceed to drill into one of the longitudinal ends of a slat located to the left of the user.

According to a second embodiment 52, the rigid body 2 is provided with an alignment member 24 having an alignment rim 28 for aligning the assistance device 1 on one of the longitudinal ends of a slat. In this second embodiment 52, the rim 28 of the alignment member 24 protrudes relative to the contact surface 12 such that the position of the tube portions 10 relative to the slat is dictated by the guide rim 14 and by the alignment rim 28 when the rigid body 2 is placed in abutment on the two contiguous edges of the slat. In this second embodiment 52, with the user positioned on the side of the ergonomic handle 11 and facing the terrace being constructed, the rigid body 2 according to this second embodiment 52 makes it possible to position the rigid body 2 on and proceed to drill into one of the longitudinal ends of a slat located to the right of the user.

According to a third embodiment 51, the rigid body 2 is provided with a removable centering guide 17 having a slot 18 positioned so as to be able to see a screw head inserted in the terrace through this slot 18 and so as to be able to align the tube portions 10 with the screw inserted. Such a guide 17 for centering and aligning the tube portions 10 of the assistance device 1 makes it possible perform drilling aligned with screws previously inserted in the terrace in a simple manner, without tracing or measuring.

In these three embodiments 50, 51, 52, the alignment members 24, 25 and the centering guide 17 have holes 26, 26′, 19 positioned and dimensioned to be able to interact with the pegs 20 on the rigid body 2 so as to rigidly secure either one of the removable alignment members 25, 26 or the removable centering guide 17 and the rigid body 2 by means of a non-deformable rigid connection. In these three embodiments, the alignment members 24, 25 and the centering guide 17 have an unobstructed area 31 positioned and dimensioned to be able to interact with a tube portion 10 and the median reinforcement 29 in such a way as to rigidly secure together either one of the removable alignment members 24, 25 or the removable centering guide 17 and the rigid body 2 by means of a non-deformable rigid connection. The drilling assistance device 1 is thus positioned precisely on the slat, in a simple manner, without tracing or measuring.

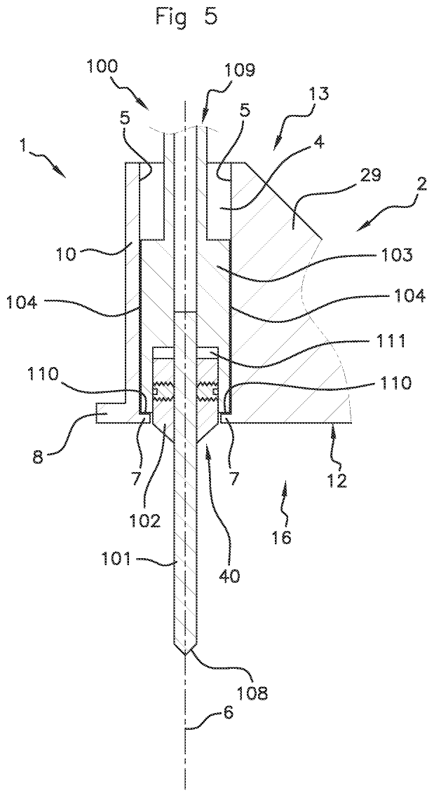

A view in cross section of a detail of an assistance device 1 according to embodiments of the disclosure is shown in FIG. 5 in conjunction with a drilling tool 100, which is partially shown. The rigid body 2 (which may also be referred to herein as a solid body 2) of the assistance device 1 forms a flat sole 8 presenting the contact surface 12 for contact with a slat, a median reinforcement 29 and a portion 10 of a cylindrical tube of revolution about the axis 6 of revolution. The drilling tool 100, partially shown, comprises a drill bit 101 the distal end 108 of which extends beyond the contact surface 12 into the half-space 16. The proximal end of the drill bit 101 (opposite its distal end) is engaged in a connection whereby it rotates and moves longitudinally as one with a guide member 103 of generally cylindrical shape of revolution about the axis 6 of revolution. The guide member 103 has an outer face 104 that is itself of cylindrical shape of revolution about the axis 6 of revolution and adapted to interact with the internal surface 5 of the guide space 4 and guide, in rotation and in longitudinal movement, the guide member 103 and the drill bit 101 in the guide space 4. The guide member 103 has at its distal end a counterbore 111 dimensioned to receive a cutter 102 mounted coaxially with respect to the drill bit 101 and the guide member 103. The counterbore 111 extending at the distal end of the guide member 103 forms a peripheral ledge 110 adapted to be able to abut on a radial expansion 7 extending into the guide space from the internal surface 5 of the guide space, forming a central cavity 40. In this embodiment, the guide member 103 is blocked in its longitudinal movement along the axis 6 by the radial expansion 7 such that its distal end 110 does not extend beyond the contact surface 12 for contact with the slat. The guide member 103 cannot mark the slat. Only the apical end of the drill bit 101 and the cutter 102 extend beyond the contact surface 12 into the drilling half-space 16. The drill bit 101 allows the slat to be drilled and the cutter 102 passing through the central cavity 40 makes it possible to form a countersink intended to be able to receive the head of a countersunk screw for building the terrace, the depth of each countersink made being controlled and regular thanks to the radial expansion. Drilling of the terrace slats is carried out without the formation of unsightly marks due to the rotation of the guide member 103.

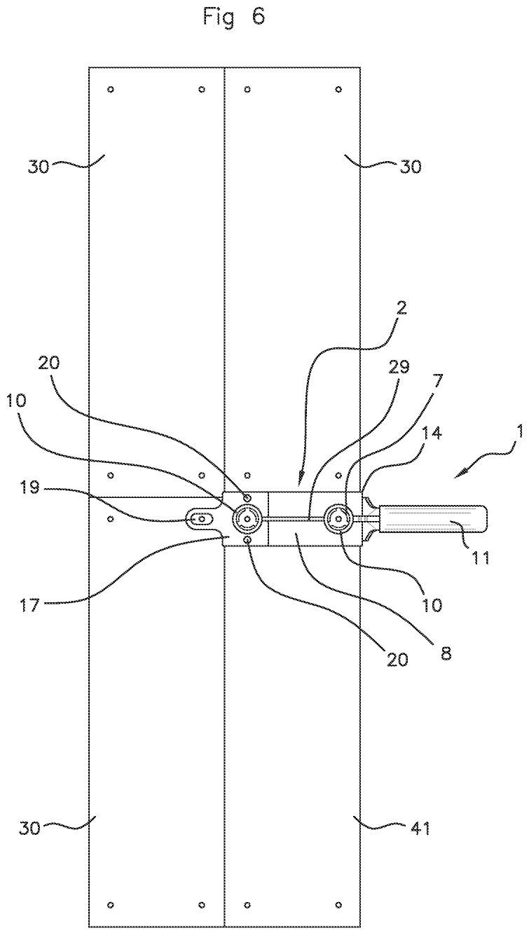

A general plan view showing a particular use of an assistance device according to the third embodiment 51 according to the disclosure is shown in FIG. 6. This particular use concerns the mounting of floor slats of a terrace when the slats 30 have already been placed on the floor of the terrace, a slat 41 being in the process of being drilled to continue with building of the terrace. The assistance device 1 according to the third embodiment 51 according to the disclosure comprises a rigid body 2 formed of a rigid plate 8, two tube portions 10, an ergonomic handle 11, a lateral guide rim 14 and a centering guide 17 rigidly secured to the rigid body 2 by interaction between the holes 19 in the centering guide 17 and the pegs 20 on the rigid body 2 and by interaction between the unobstructed area 31 of the centering guide 17 and the tube portion 10 and the median reinforcement 29 of the rigid body. Thus, the centering guide 17 is connected to the rigid body 2 by means of a non-deformable rigid connection. The assistance device 1 according to the third embodiment 51 shown in FIG. 6 is moved over the upper surface of the slat 41 being drilled, the lateral guide rim 14 being kept pressed on the longitudinal edge of the slat 41 and such that the slot 18 in the centering guide 17 becomes superposed with a screw head in the adjacent slat. Thus, the drilled hole in the slat 41 will be perfectly aligned with the drilled hole in the adjacent slat 30, this perfectly esthetic alignment being obtained without measuring or tracing.

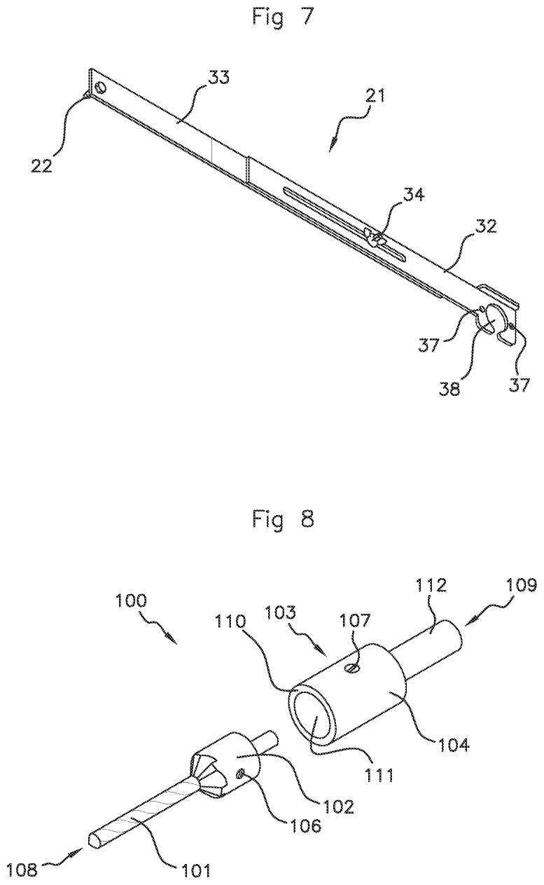

A perspective view of a spacing arm 21 capable of being used with the solid body 2 in a fourth embodiment of an assistance device 1 according to the disclosure is shown in FIG. 7. The spacing arm 21 is formed of two brackets 32, 33 for adjusting the length of the spacing arm 21, adapted to be able to slide longitudinally relative to one another in a first position of blocking means 34 in which the length of the spacing arm 21 may be adjusted, and to be able to be held fixedly relative to one another in a second position of these blocking means 34 in which the length of the spacing arm 21 is kept fixed. A first bracket 32 has, at one of its longitudinal ends forming a first longitudinal end of the spacing arm 21, a substantially flat part having an unobstructed area 38 positioned and dimensioned to be able to interact with a tube portion 10 and the median reinforcement 29 of the solid body 2 in such a way as to rigidly secure the removable spacing arm 21 and the rigid body 2 by means of a non-deformable rigid connection. The flat part of the spacing arm 21 also has holes 37 positioned and dimensioned to be able to interact with the pegs 20 on the rigid body 2 in such a way as to rigidly secure, in combination with the unobstructed area 38, the removable spacing arm 21 and the rigid body 2 by means of a non-deformable rigid connection. The spacing arm 21 is reversible and may be rigidly secured to the rigid body 2 on the right or on the left depending on the desired use. A second bracket 33 has, at one of its longitudinal ends forming a second longitudinal end of the spacing arm 21, a centering stud 22 dimensioned and oriented to be able to interact with a drilled hole made in the slat and to position the rigid body 2 at a predetermined distance from this drilled hole. The spacing arm 21 is provided with means 34 for blocking/unblocking the first bracket 32 and the second bracket 33 in longitudinal movement relative to one another, adapted to be able to adjust the length of the spacing arm 21 according to the desired distance between two adjacent drilled holes.

An exploded perspective view of a detail of a drilling tool 100 capable of being used in association with a drilling assistance device 1 according to embodiments of the disclosure is shown in FIG. 8, in which the means for driving in rotation the drill bit 101 and the guide member 103 for guiding the drilling tool 100 are not shown. The drilling tool 100 comprises a guide member 103 for guiding the rotation of the drill bit 101 in a guide space 4 of a drilling assistance device 1 according to embodiments of the disclosure. This guide member 103 has at its proximal end 109 a rod 112 adapted to be able to interact with a chuck (not shown) of the drilling tool 100. It has, at its distal end, a cylindrical tubular part of revolution the outer face 104 of which is adapted to guide the guide member 103 in the guide space 4 of the assistance device 1. This distal end forms a counterbore 111 for receiving the drill bit 101 and a cutter 102 mounted coaxially with and rigidly secured to the drill bit 101. The guide member 103 comprises a screw 107 for immobilizing the drill bit 101 relative to the guide member 103. The counterbore 111 forms a peripheral ledge 110 adapted to be able to come into abutment on the radial expansion 7 extending into the guide space 4 of the assistance device 1 according to embodiments of the disclosure. Thus, the only rotating elements of the drilling tool 100 kept in contact with the slat are the elements necessary for drilling the slat, the guide member 103 being kept at a distance from the slat during drilling.

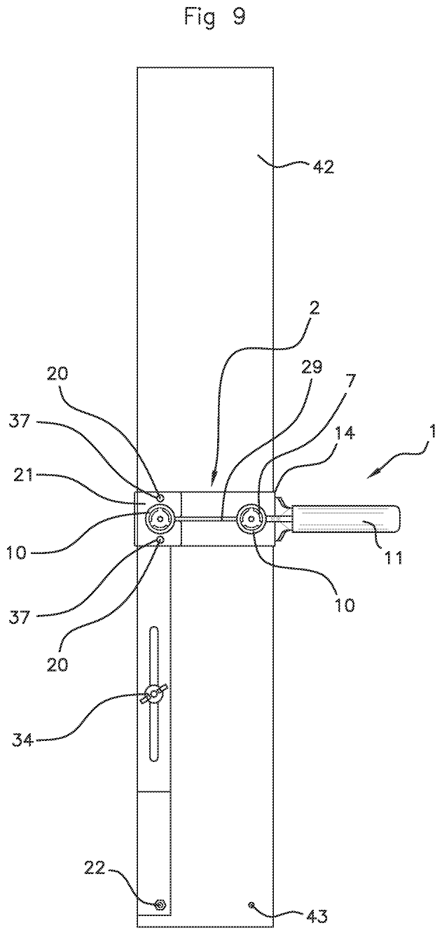

A general plan view showing a particular mode of use of a drilling assistance device according to embodiments of the disclosure provided with a spacing arm 21 is shown in FIG. 9. This particular use concerns the mounting of a long slat 42 requiring drilling—notably drilling/countersinking—in a middle position interposed between the two longitudinal-end drilled holes in the slat 42. This particular use notably concerns the mounting of such a long slat 42 along the edge of the adjoining wall of the terrace under construction. For this particular use, during a first step of drilling/countersinking, a first longitudinal-end drilled hole/countersink 43 is produced by means of an assistance device 1 according to the first embodiment 50 described in FIG. 4, the assistance device 1 being equipped with an alignment member 25 adapted to abut on the longitudinal end of the slat 42, shown on the left-hand side in FIG. 9. In a second step of drilling/countersinking, the alignment member 25 is removed from the assistance device 1 and a spacing arm 21 as shown in FIG. 7 is adapted to the assistance device 1 and the length of the spacing arm 21 is adjusted by actuation of the blocking means 34 such that the centering stud 22 interacts with the longitudinal-end drilled hole/countersink 43 in the slat 42 and such that the center of the cylindrical tube portions 10 are aligned in the middle of the slat 42. In addition, the lateral guide rim 14 of the solid body 2 allows adjustment of the position transversely in relation to the slat 42. In this way, a middle drilled hole/countersink is produced that is perfectly aligned with the first drilled hole/countersink 43, this perfectly esthetic alignment being obtained without measuring or tracing. In this particular mode of use of a drilling assistance device according to embodiments of the disclosure, it is possible to produce a drilled hole/countersink (not shown) at the longitudinal end of the slat 42, using the assistance device 1 equipped with the spacing arm 21 and to move same in translation longitudinally on the slat 42 such that the centering stud 22 interacts with the middle drilled hole/countersink previously produced. However, there is nothing to prevent the use of the assistance device 1 according to the third embodiment 51 described in FIG. 4, the assistance device 1 being equipped with an alignment member 24 adapted to be in abutment on the longitudinal end of the slat 42 shown on the right-hand side in FIG. 9. Thus, the drilled holes/countersinks in the slat 42 are perfectly aligned with one another and with drilled holes/countersinks in an adjacent slat, these perfectly esthetic alignments being obtained without measuring or tracing.

In an embodiment (not shown) of an assistance device according to the disclosure, the rigid body may be made of a solid material, at least one guide space being made in the mass of the rigid body. Naturally, each of the guide space(s) form(s) an internal surface suitable for guiding the guide member of a drilling tool, of cylindrical shape of revolution about an axis of revolution orthogonal to the plane of the contact surface. In this embodiment, the drilling of the terrace slat will be carried out along a drilling axis kept orthogonal to the main plane of the slat while maintaining the esthetics of the terrace. In another embodiment not shown, there is nothing to prevent the assistance device from having a single guide space formed by a single tube portion or in the mass of the rigid body.

In an embodiment (not shown) of an assistance device according to the disclosure, the rigid body may be formed in at least two separate parts connected to one another by a rigid connection, notably by a rigid connection of adjustable length, each part of the rigid body having a flat sole, the flat soles of each part of the rigid body together forming the contact surface. Advantageously, in this embodiment, each rigid body forms a guide space such that the spacing between the at least two—notably the two—guide spaces and the drilled holes may be modified, in particular according to the width of the slat to be drilled. In this embodiment (not shown) of an assistance device according to the disclosure, there is nothing to prevent the rigid body being in the form of a rigid plate, this rigid plate may be formed in at least two separate parts connected to one another by a rigid connection, notably by a rigid connection of adjustable length, each part of the rigid plate having a flat sole, the flat soles of each part of the rigid plate together forming the contact surface. Advantageously, in this embodiment, each part of the rigid plate has a cylindrical guide tube portion such that the spacing between the at least two—notably the two—guide tube portions and the drilled holes may be modified, in particular according to the width of the slat to be drilled.

The disclosed devices and methods may be the subject of numerous variants and applications other than those described above. In particular, it goes without saying that unless otherwise stated, the various structural and functional features of each of the embodiments described above should not be considered as combined and/or closely and/or inextricably linked to one another, but on the contrary as simply juxtaposed. In addition, the structural and/or functional features of the various embodiments described above may be subject, in whole or in part, to any different juxtaposition or any different combination. For example, the shape of the rigid body and the radial expansion, the dimensions of the drilling assistance device, notably, may be adapted without departing from the disclosure.

1. A device for assistance in drilling through a board by means of a drilling tool of a type equipped with a drill bit, means for driving in rotation the drill bit, and a guide member for guiding the drill bit in rotation and in movement along a longitudinal axis of the drill bit, the guide member having an outer face of generally cylindrical shape of revolution about an axis of rotation of the drill bit; the device comprising:
a rigid body having a flat sole forming a surface of the rigid body, the surface providing a contact surface for contact with the board; and
at least one guide space defined by the rigid body, forming a bore passing through the rigid body, and opening onto the flat sole;
each guide space being delimited laterally toward an outside by a cylindrical internal surface of revolution about an axis of revolution orthogonal to a main plane of the flat sole, the internal surface being adapted to be able to interact with the guide member and guide the drill bit in rotation and in longitudinal movement along the axis of revolution;
the internal surface of each guide space having a radial expansion for stopping the guide member in abutment on the radial expansion during the longitudinal movement of the drilling tool in a direction of the board, the radial expansion extending into the guide space from the internal surface and forming an axial cavity dimensioned such that the drill bit can pass through it.

2. The device of claim 1, wherein the rigid body comprises a plurality of the guide spaces.

3. The device of claim 1, wherein at least one part of the rigid body is in a form of at least one rigid plate, the at least one rigid plate forming the flat sole, and the at least one rigid plate having the at least one guide space.

4. The device of claim 1, wherein the flat sole of the rigid body is rectangular in shape.

5. The device of claim 1, wherein the cylindrical internal surface delimiting the each guide space is formed of an internal surface of a portion of cylindrical tube of revolution extending from the flat sole into a half-space providing a drilling space, the half-space being opposite a half-space extending facing the surface of the flat sole.

6. The device of claim 4, wherein the flat sole that is rectangular in shape is extended by a rim providing lateral guide rim for guiding the device in lateral movement along the board, the lateral guide rim extending:
protruding relative to the contact surface of the flat sole;
from only one of four edges of the flat sole that is rectangular in shape; and
in a half-space extending facing the contact surface.

7. The device of claim 6, further comprising a plurality of cylindrical tube portions arranged in such a way as to form an alignment of portions, with an axis of alignment perpendicular to the lateral guide rim.

8. The device of claim 1, further comprising a centering guide having a slot positioned such that a screw head inserted in a terrace can be seen through the slot and such that at least one of the guide spaces can be aligned with a screw having the screw head inserted.

9. The device of claim 8, wherein the centering guide is removable with respect to the rigid body and defines at least one hole adapted to receive and interact with at least one peg on the rigid body in such a way as to rigidly secure the centering guide and the rigid body by means of a non-deformable rigid connection.

10. The device of claim 1, further comprising a spacing arm for spacing the device relative to a drill hole made in the board, the spacing arm being a rigid arm of adjustable length, mounted rigidly secured to the rigid body and having at its longitudinal end opposite its end rigidly secured to the rigid body, a centering stud dimensioned to interact with the drill hole made in the board and to keep the rigid body of the device at a predetermined distance from the drill hole made in the board.

11. The device of claim 1, wherein at least one radial expansion, of the radial expansions of the internal surfaces of the at least one guide space, has at least one radial notch for evacuating sawdust during drilling.

12. The device of claim 1, wherein the each guide space has a depth chosen and adapted to be at least equal to a distance separating a distal drilling end of the drill bit and a distal end of the guide member.

13. The device of claim 1, further comprising at least one alignment member for aligning the rigid body on a longitudinal end of the board, the alignment member being removable relative to the rigid body and defining at least one hole adapted to receive and interact with at least one peg on the rigid body in such a way as to rigidly secure the alignment member and the rigid body by means of a non-deformable rigid connection; the alignment member having an alignment rim adapted to extend:
protruding relative to the contact surface of the flat sole; and
in a half-space extending facing the contact surface.

14. The device of claim 1, wherein the rigid body is shaped so as to have a gripping member forming an ergonomic handle.

15. The device of claim 1, wherein the drilling tool is further equipped with a cutter mounted coaxially and such that it rotates as one with the drill bit, and the axial cavity in the radial expansion is dimensioned such that the cutter can pass through it.

16. A method for drilling through a board, the method comprising:
selecting a drilling tool, the drilling tool being equipped with a drill bit, means for driving in rotation the drill bit, and a guide member for guiding the drill bit in rotation and in movement along a longitudinal axis of the drill bit, the guide member having an outer face of generally cylindrical shape of revolution about an axis of rotation of the drill bit; and
using the device of claim 1 for assistance in drilling through a board, wherein the device of claim 1 is used in such a way as to carry out regular and esthetic drilling of the board without taking measurements and without tracing.
